(19) United States
(12) Patent Application Publication
(10) Pub. No.: US 2010/0134279 A1
(43) Pub. Date: Jun. 3, 2010

(54) Method and system of automatic generation of travel based action

(76) Inventor: Roy Schwartz, Mountain Lakes, NJ (US)

Correspondence Address: Roy Schwartz, 21 Ronarm Drive, Mountain Lakes, NJ, 07046-1422, US

(21) Appl. No.: 12/626,898

(22) Filed: Nov. 28, 2009

Related U.S. Application Data
(60) Provisional application No. 61/118,504, filed on Nov. 28, 2008.

(51) Int. Cl. G08B 1/08

(52) U.S. Cl. 340/539.13

(57) ABSTRACT

We describe a system that is useful for a traveler to automatically be notified by a portable device when his destination has arrived. Unlike, previous methods that required the traveler to set the alarm each time when he starts the travel and then to turn of the alarm when he reaches the destination, our invention does not require any day intervention by the user. Some simple one time entries, by a commuter for example, will allow the portable device to generate alarms at the proper destination and time without requiring the commuter to enable and disable the alarm.

A user defines a travel as a pair of originating and destination location points. A travel Alarm System on a portable device is described which generates an alarm at the predefined destination point only when the portable device automatically detects a travel from the predefined starting point to the predefined destination point. The location information to aid the detection of a travel can be done via GPS on the phone, assists from the wireless carriers or other ways to determine location information. Furthermore, instead of generating a notification to the user of the portable device, a notification can be sent to a third party.

### BACKGROUND OF THE INVENTION

1. Field of the Invention

This invention relates to methods for generating notifications and actions based upon reaching a specific destination.

2. Description of Related Art

Commuters on a bus or a train have a need to be reminded when they are about to reach their stop because they may want to catch up on sleep until their destination arrives. The ideal case would be for the commuter to travel with a partner or an assistant who doesn't sleep and is responsible enough to wake up the commuter at the appropriate time, but not a moment earlier.

Since this is not possible in general, people fall back on ad hoc measures. Some commuters just try to struggle to keep themselves from ever falling asleep. Another approach taken is to try to never to do deep (or restful) a sleep, but may be just try to close their eyes without ever sleeping.

Other, tech savvy commuters, try to use tools on portable devices to wake them up in some reasonable time. Alarm clocks on cell phones, PDAs, or other portable devices can be used to set an alarm at the originating point and to go off within some duration; For example, if a trip takes 1 hour then a commuter may set the alarm to go off in 45 minutes. This has a few disadvantages, first you sleep less than the full hour and secondly, if there is traffic and it takes an hour and a half, in our example, to reach the destination then you get significantly less sleep than possible in the ideal case. Thirdly, you have to enable the alarm at the originating point or rather you have to remember to enable it. If you forget to set the alarm then you may sleep through and miss your destination stop or you may keep checking to see if you have set the alarm rather than getting a deep restful sleep.

A partial solution, to the third problem, is to have a recurring alarm that can be set to go off at the same time every day or every weekday. You also need the alarm to be capable of setting multiple recurring alarms, one for the morning commute and one for the evening commute. Unfortunately, this also has significant downsides. People may take buses at different times or buses may be late, so in these cases the alarms are going off too early or too late and you may miss your destination if you take an earlier bus, for example.

A better solution is to have a tool on your portable device that accepts your destination location and then uses your location detection capability (e.g. GPS) to give an alarm when you are reaching your destination. This may seem like a significant improvement, unfortunately, it also suffers from the same problems as the recurring time alarm. You have to enable your location alarm before every travel and disable it after reaching your destination otherwise you will get repeated false alarms. For example, suppose you have set your alarm to go off when you reach your stop which is 1 mile from your house. After reaching your stop, if you don't turn off the alarm, every time you go somewhere and come back the alarm will go off. If you go to a supermarket, pick your kids up, etc and then come towards the house, your alarm would go off.

So you will have to choose to disable it. That means you will have to remember to enable it the next time. So in this aspect, this solution is as bad as having a recurring time alarm. Thus there is no satisfactory solution to solve the sleeping commuter problem. A large portion of the public takes mass transit on buses, trains, etc., and would like to get a restful sleep and not be distracted. Of course, its not just sleep, commuters may want to do concentrated reading or work, or just listen to music or watch TV or more, but are constantly distracted by checking if they have reached their destination,

### SUMMARY

The novel idea of this invention is to allow to setup alarm upon reaching particular destination point while taking particular traveling route. As described above, previous implementations require to manually set-up the alarm based on the destination point every time when user takes a trip to this point because these implementations do not have the capability to figure out for which trip or travel route the alarm should be triggered. In the current invention a portable device will automatically determine when specific route has been traversed and only for the preset routes after reaching the preset destination point will it generate an alarm. This will eliminate the need for the user to manually restart the alarm for each specific journey.

A portable device can measure its current location at a specific time and using multiple measurements can detect when a preset route is being traveled. The portable device doesn't have to always take the location measurements, but can take it periodically to determine if it is traveling on a route. Furthermore, the device can stop taking measurements for some extended period if it determines that it is not feasible to get to any points on the preset traveling route within the period. Location measurements can be made via various methods including, GPS on the phone, location of cell towers, assistance from the network, or other methods.

The system will allow the users who want to nap while traveling on the bus or train or do not know when their stop should be, to setup an alarm for the journey that will be generated when they close to their destination. It will also allow for the third parties to receive notification when specific destination is reached by the other user who has portable device. This could be useful for the parents that need to pick up their children who traveling on the bus or to know when the bus arrives to particular destination point assuming that the bus has portable device. The system will be able to automatically determine at least if particular journey or travel route is taken place and destination point is reached and only in this case to generate an alarm and eliminate the need to setup the alarm every time when the journey takes place.

Other criteria can be used to generate the alarms, for example, one can say that a preset route should be enabled for alarming only on weekdays or at special times. Also one can define a duration within which the travel needs to be completed or equivalently a minimum average velocity. The travel route can be generalized further to include multiple sequential points that have to be reached through the journey.

The definition of the multiple travel routes can be done by individually defining each route to be consisted of a sequence of origination and destination points. The traveling routes can also be defined by the origination and destination points taken from sets of points that have to be reached based on specific sequence defined for these sets.

It can be appreciated that many variations and applications can be made of this invention by a skilled person.

### BRIEF DESCRIPTIONS OF THE DRAWINGS

FIG. 1 illustrates the travel of the portable device over time.

FIG. 2 illustrates the portable device and its subcomponents useful in automatically generation location based actions.

FIG. 3 illustrates the observable travel and unobservable travel history.

FIG. 4 illustrates the preset route that is to be matched before triggering some action.

FIG. 5 illustrates multiple preset routes where matching any one of them is sufficient to trigger some action.

FIG. 6 illustrates a preset route with intermediary regions to be traveled through.

FIG. 7 illustrates the overall method for automatically generating location based actions.

FIG. 8 illustrates a matching method which works with a single preset route and regular location measurements.

FIG. 9 illustrates a matching method which works with multiple preset route and regular location measurements.

FIG. 10 describes the preset criteria hierarchy.

### DETAILED DESCRIPTION OF THE INVENTION

A point is defined in geometry as an infinitesimal quantity making up a line or surface, however, in day to day language an object (e.g. portable device or vehicle) is also spoken as occupying a point in space even though it has extension. When we speak of “point” or “location point”, we are using it as in the day to day language.

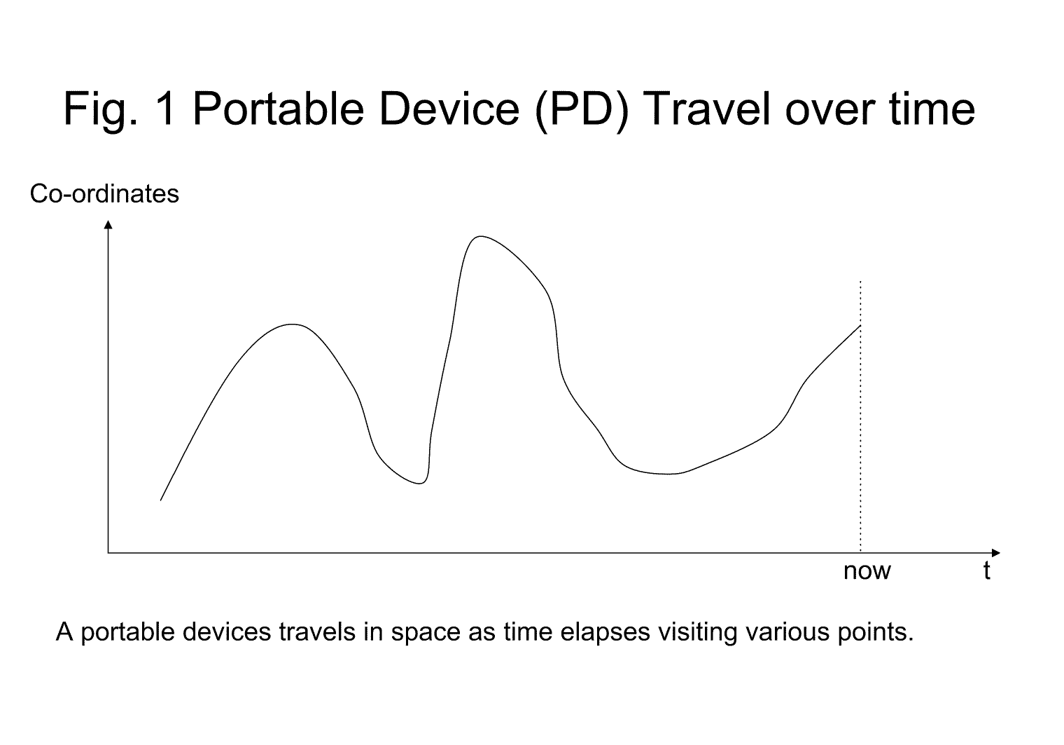

A portable device travels or traverses through a sequence of location points as time elapses. Any time interval defines a travel which will include a sequence of points traversed by the portable device (PD) during that time interval. FIG. 1 illustrates the travel of a portable device over earth's surface (i.e. co-ordinates on y-axis) as time flows on the x-axis. The PD travels in space, as time elapses, sometimes resting at a particular point for an extended duration, while at other times quickly moving through different points.

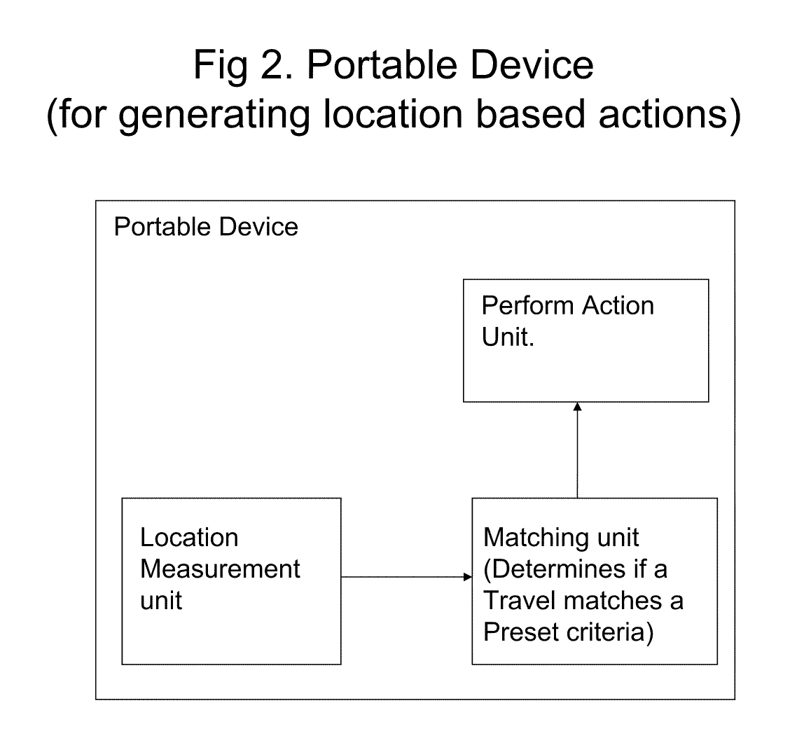

FIG. 2 illustrates the portable device that automatically generates travel based action. The location measuring unit takes or measurements or receives location information from outside, for example, GPS, wireless carriers, etc. It relays the location related measurement (e.g. latitude/longitude, altitude) to the matching unit which based on preset criteria a preset route matches the current travel so far. If no match is found then the location measurement unit continues to take new measurement. However, if a match is found then additionally the “perform action unit” perfoms the preset action.

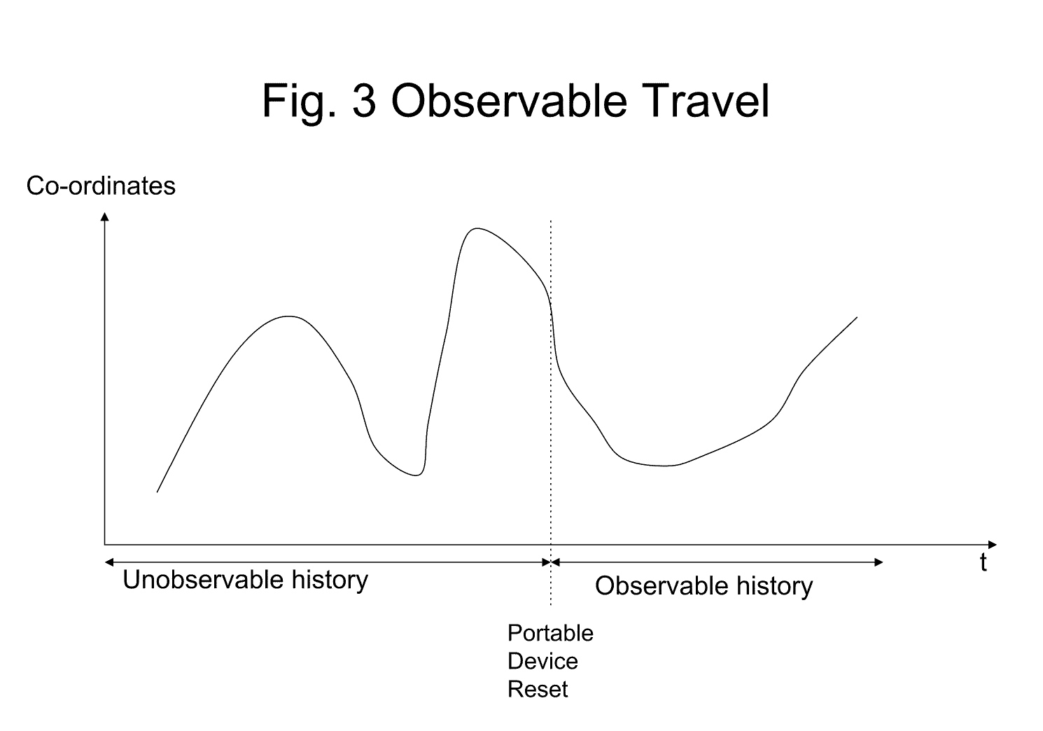

All the travel history of a PD may not be available at the current time. FIG. 3 illustrates the “observable history” of travel. A PD's travel history may be lost because the device is reset (where the configured parameters, history, etc are deleted as oppose to when turning the device on or off) or its memory is erased, or the location measurement unit may be powered down for a long enough time that the PD can no longer be sure where it has been and has not been. In such a case the past travel history becomes “unobservable history” and the new measurements from now onwards form the new observable history of PD's travel.

### Region:

A region is identified by a region identification parameter which a set of parameters entered by the user. Those parameters are used for determining a region as a collection of points forming a continuous area within the preset boundaries. A point in a region can be a starting point, ending point or an intermediary point on a preset route. The exact size of the region is chosen by the application or the user to be a meaningful area. For example, a user wanting to know when a bus stop is reached would wish to define the area of the bus stop as the destination region in a preset route. More practically, the user may want to be alerted earlier than actually reaching the bus stop and may choose to specify a circular area surrounding the bus stop by specifying the radius as the destination region.

In other contexts, a user may want to define when he leaves a city or arrives at a town. In these cases, the area defined by the city or town could be used as the starting, destination or intermediary regions. In general a region could be the area surrounding the address of a house, office, an intersection, or a bus stop, or could include an additional surrounding region defined by circle or semicircle, or other shapes. Furthermore, the region could be the area of a town, city, county, state, or even country. A user may also enter a latitude and longitude pair or select a continuous region defined on a map.

### Preset Route

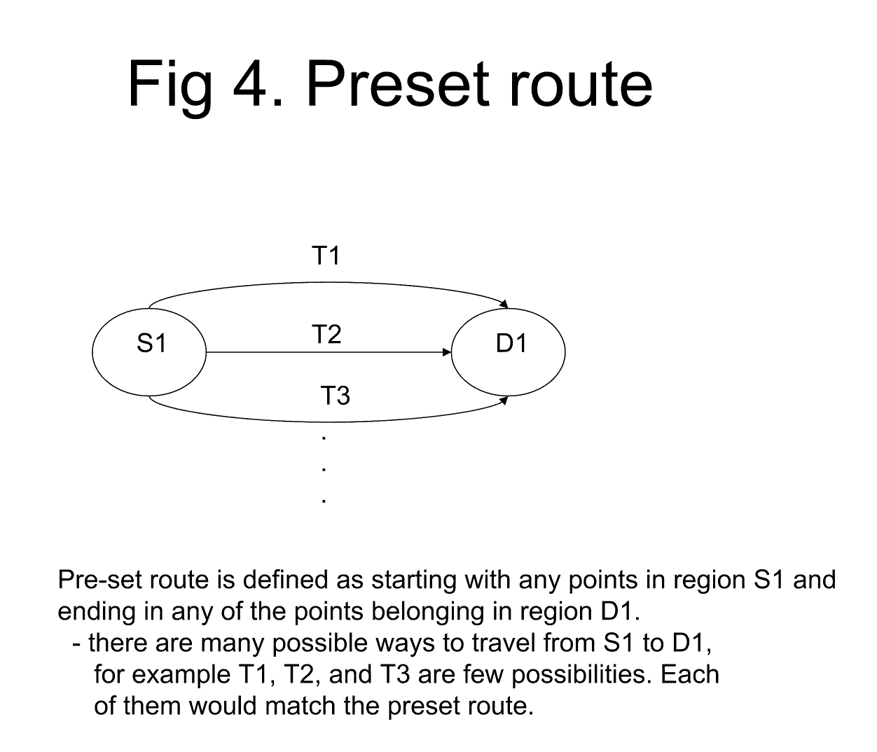

A preset route is illustrated in FIG. 4 and is defined as a route with a starting point from any of the points belonging to a starting region and ends in an ending point belonging to any of the points from a destination region associated with the starting region. Thus a route consists of a destination region and an associated starting region.

With the description of a region, the example of a preset route in FIG. 4 will become clear. S1, the starting region, and D1, the destination region, are two defined regions, such that the preset route is satisfied by the PD's travel (or the measurements taken during the PD′ travel) if a point from S1 region was observed followed eventually by a point from the D1 region; that is the PD has traversed through points in S1 region and in D1 region. FIG. 4 illustrates that there are many ways to travel from S1 to D1 via different intermediary points. The figure shows example travels T1, T2 and T3 that all satisfy the preset route.

### Preset Route Criteria:

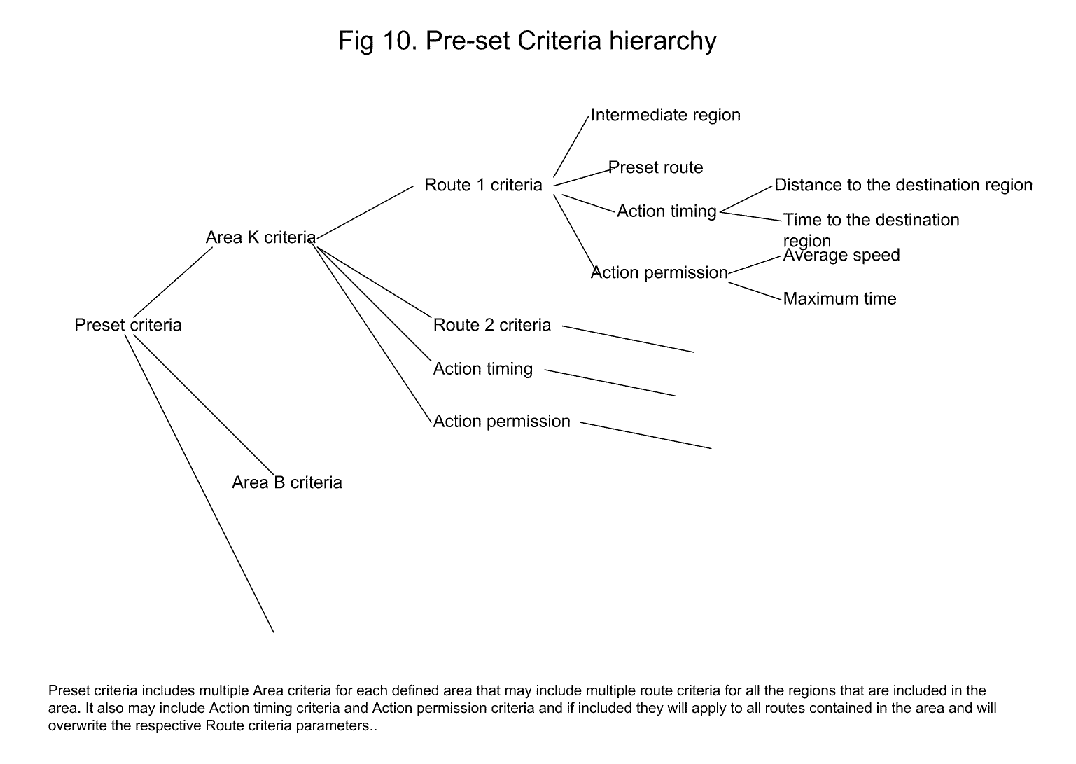

A preset route criteria, as described in FIG. 10, must include a preset route and may include additional criteria's associated with the route. The additional criteria may include “action timing” criteria, “action permission” criteria, and “intermediate region” criteria. An action timing criteria can be a “distance to the destination region” criterion which indicates to the PD that it should perform the designated action (e.g. alerting the user) when the PD is a preset distance away from destination region while traversing the associated preset route from starting region to the associated destination region. Also an action timing criteria can be a “time to the destination region” criterion which indicates to the PD that it should perform the designated action when the PD is a preset time away from reaching the destination region while traversing the associated preset route from starting region to the associated destination region.

A preset route may be traversed, but the designated action may not be performed if an action permission criterion threshold was not met. For example, average speed may be used as an “action permission” criterion such that unless the route was traversed with a velocity greater than a minimum preset velocity then the PD will not perform the designated action upon reaching the destination region of the route. Another example of an “action permission” criterion involves specifying that the time to traverse a route should be less than a preset time otherwise the action is not performed even upon reaching the destination region of the associated route.

The “intermediary region” criteria specifies one or more intermediary regions and perhaps the order in which they must be traversed through while traversing the preset route starting from starting region and ending in the destination region. If those intermediary regions are not traversed or if they are traversed out of order (if order was specified) then the designated action is not triggered even upon reaching the destination region.

### Preset Area Criteria:

An area criteria, as illustrated in FIG. 10, includes one or more route criteria. It may also include “global” action timing and action permission criteria that apply to all the routes contained in the area.

### Preset Criteria:

A preset criteria includes one or more area criteria.

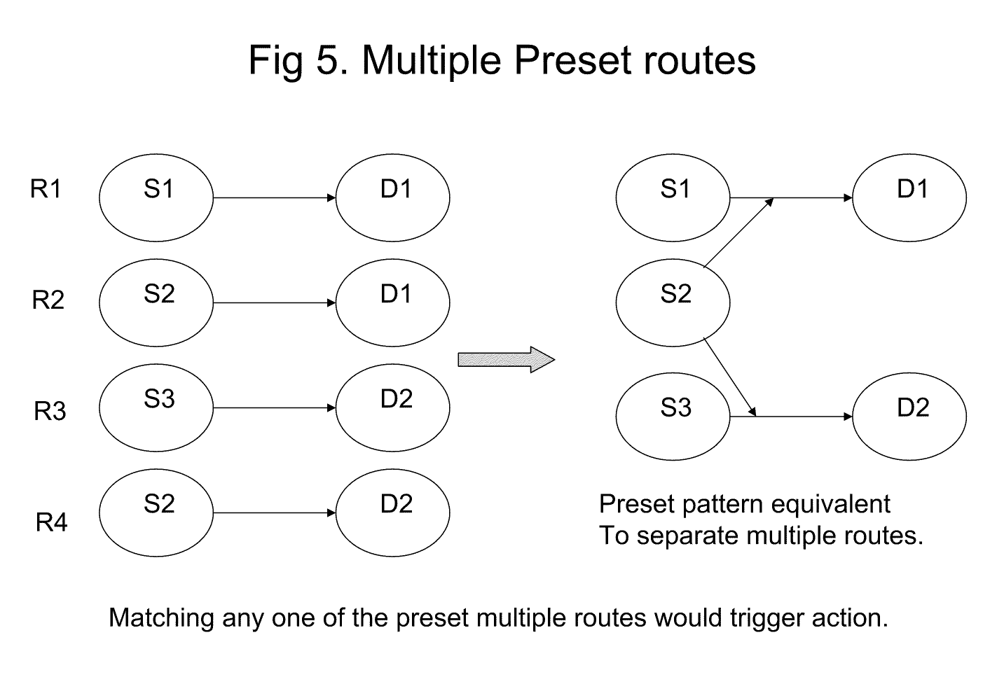

As mentioned instead of just a single route being preset, the PD's preset criteria can include multiple routes as illustrated in FIG. 5. Four routes are preset to be detected and matched with the observed (and measured) travel history, the route from S1 to D1, S2 to D1, S3 to D2 and S2 to D2. Matching any one of the preset multiple routes would trigger action. The right side of FIG. 5 shows a travel pattern or a more compact figure with fewer circles such that any path on the graph is acceptable as a matched route.

Once a preset route is matched with the travel of a portable device, the observable history may be set to empty or not based on what is defined in the preset criteria. That is upon satisfying a preset route, in one embodiment, the past travel history is erased and a new observable history is started. In another embodiment, the past observable travel history is not erased, rather the observable history continues to grow and if further preset routes are detected, even if it overlaps the last detected route, an action is triggered.

As an example, suppose that a user has set a route from NYC to Baltimore and another route from Baltimore to DC. If Baltimore is reached form NYC then an action is triggered, but then suppose the PD further travels to DC, should another action be triggered? If the past travel history was erased then the PD would only see that a Baltimore to DC travel happened and since that does not match a preset route, there is no need to trigger an action, however, if the past travel history was not erased then upon reaching DC, the NYC to DC route would be matched and an action would be triggered.

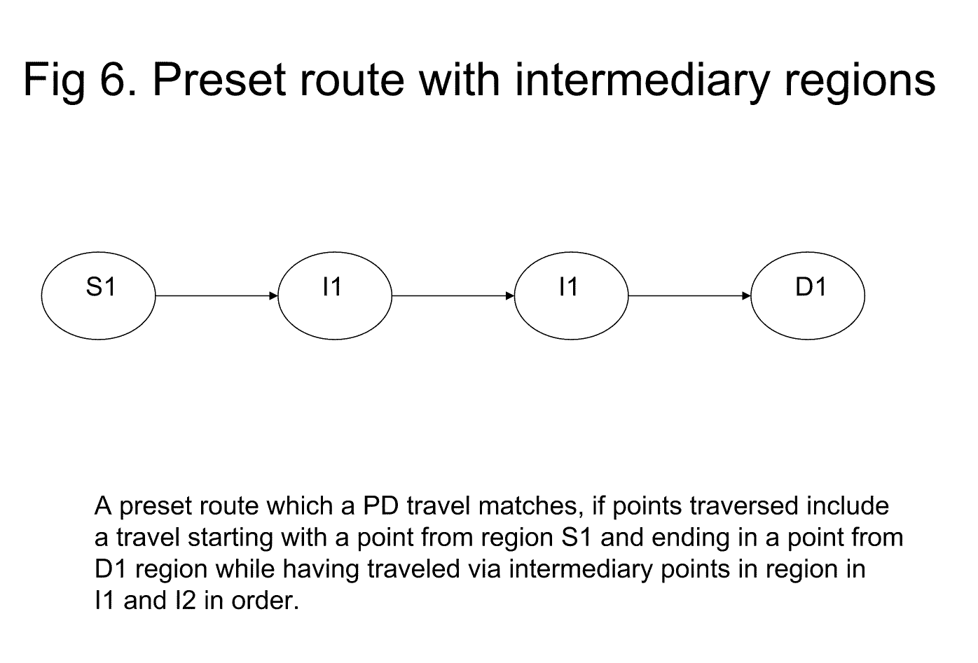

FIG. 6 illustrates the possibility that a preset route could additionally contain intermediary regions that must be traversed in order from the starting to the ending region. In FIG. 6, a preset route which a PD travel matches, if points traversed include a travel starting with a point from region S1 and ending in a point from D1 region while having traveled via intermediary points in region in I1 and I2 in order. A destination region in one preset route can also be a starting or intermediary region in another preset route.

Once a preset criteria is matched then an action is triggered. Notification is a common action to be triggered. The notification can be given to the user of the PD in form of an audible alarm, visual alarm, vibration, or voice prompts. Secondly, the notification could be given to third parties, like parents waiting for their child's arrival from college. Notification to third parties can be in form of email, SMS, or a voice call. When an alert is given to a user the managing of that alert can be as with current alarm system with the ability to snooze for a time period.

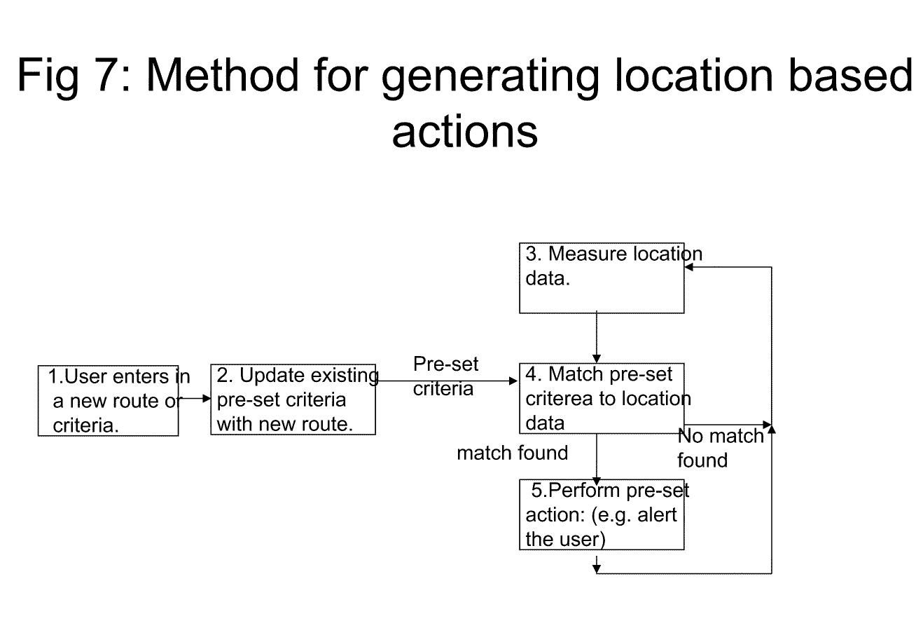

FIG. 7 illustrates the overall steps in the process where the user in step 1 enters the new route to be monitored or additional criteria to be applied to existing route. The entering of a new route requires entering of the starting and the destination region which may be entered as a text address, clicking on a map, or being in the region and selecting the current location as belonging to the region. Other criteria may also be entered.

In step 2, the existing preset criteria is updated with additional new route or new criteria. The PD continues to measure location data in step 3. The “location data” is measured and collected in the background transparently and automatically with respect to the user of the PD. Also supplementary, but related information, like current velocity may be collected. In step 4, the preset criteria and the location data measured (including past ones) are used to see if a route is matched and any other criteria are satisfied. If a satisfactory match is not found then the PD will wait till the next period to take a new measurement. If a match is found then any preset actions, like alerting the user, will be performed in step 5. The PD continues in the background, automatically and transparently to the user, to take more measurements and check if any preset criteria are matched, and no further monitoring or action is required by the user.

Matching Preset Criteria with a Single Preset Route:

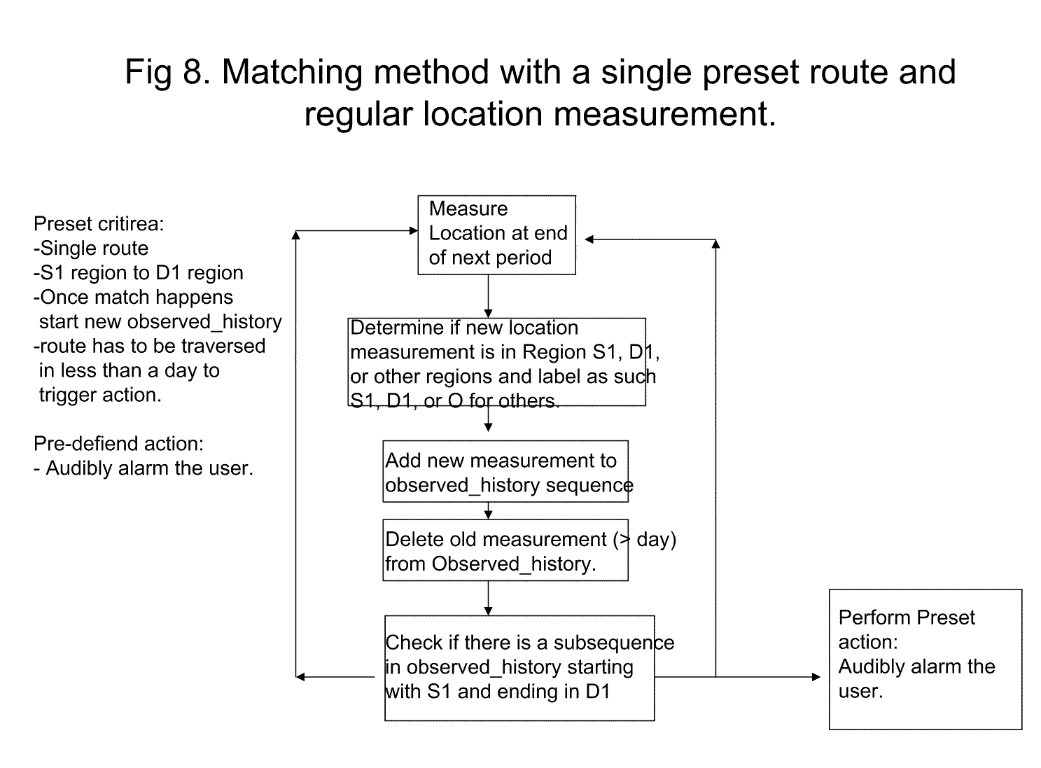

FIG. 8 illustrates a matching method that works when a single route is preset and regular location measurements are taken by the PD (e.g. every 30 seconds). The preset criteria includes starting at any point in region S1 and ending in destination region D1. Once a preset route is matched by the observed history, start a new observed history, and finally, the duration of the travel should not take more than a day to go from a starting region to a destination region. The preset action is to audibly alarm the user of the PD.

A location measurement is taken periodically (e.g. every 30 seconds). After a location measurement is taken, we determine if the measured location or “location data” belongs to region S1, D1 or neither. We label the new measurement as S1 or D1 based on whether it belongs to S1 or D1, and we label it O (or other) if it belongs to other regions. The new label is added to the observed history of the sequence of labels. Any labels or measurements that have become over a day old can be deleted since they cannot help match a preset route.

Finally, we check if there is a subsequence in the “observed history” sequence of labels that start with S1 label and end with the D1 label. Checking the subsequence can be done by any regular expression matching algorithm which looks for regular expression “[O,S1]*S1[[O]*D1” which means the subsequence begins with a prefix of zero or more characters of O or S1, followed by a single S1 character, followed by zero or more “O” character and ending with a D1 character. For optimization purposes, we do not need to run the regular expression matching algorithm on the entire observed history each time, but can just incrementally check if a match would happen given the new label and the past state using for example finite state automaton's for matching regular expressions.

### Irregular Location Measurement:

Instead of regular location measurement (e.g. every 30 seconds), we could figure out the minimum amount of time it will take the PD to reach any point in S1 or D1 assuming a reasonable maximum vehicle velocity (e.g. 75 mph). The PD can wait or sleep until that time before taking the next measurement. This will save greatly on power if GPS is used to measure location information.

### Matching Preset Criteria Containing Multiple Preset Route

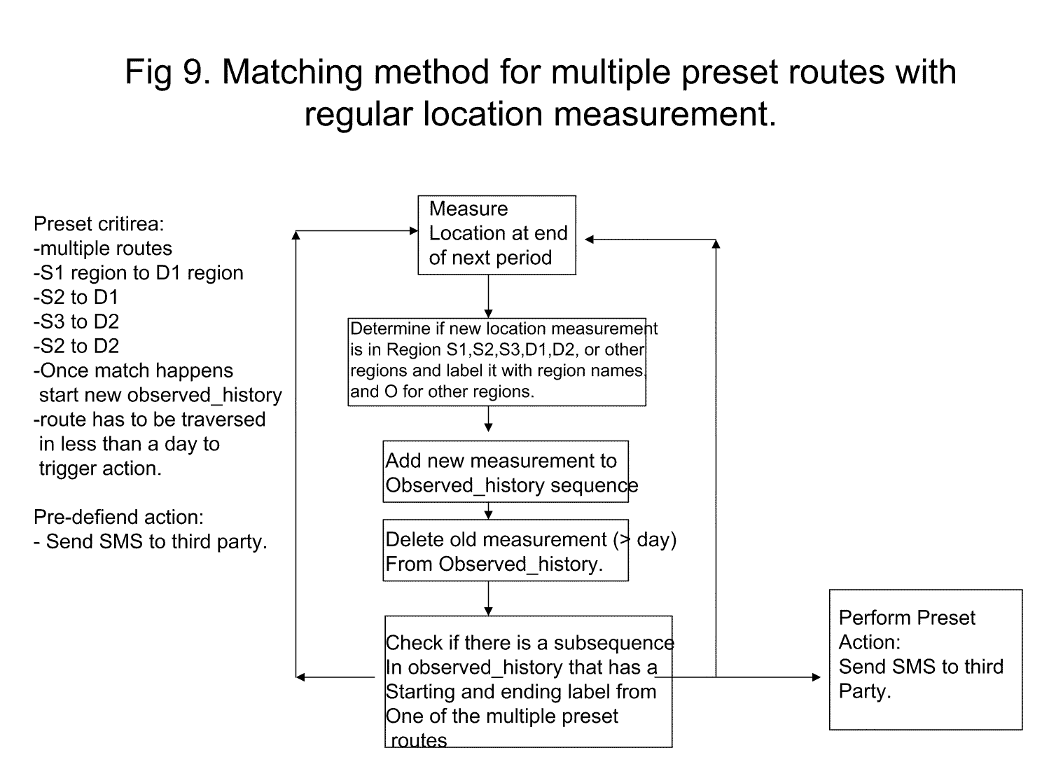

FIG. 9 illustrates an example of detecting when any one of the multiple routes may be matched by the travels in the measured observed history. The preset criteria defines the 4 routes out of which matching any one by the observed history should trigger an action. The routes are S1 to D1, S2 to D1, S3 to D2, and S2 to D2. The rest of the criteria is the same as in FIG. 8, however, the preset action differs as it sends a notifying SMS to a preset third party.

The method is similar to that illustrated in FIG. 8, however, the labeling of newly measured locations can be S1, S2, S3, D1, D2 or O for others. And when a subsequence is checked in the observed history, it should check that the starting and ending labels of one of the four preset routes forms a subsequence. If it does then an SMS is send to the preset third party. Checking if the subsequence matches one of the preset route can be done by seeing if the following regular expression hits a match over the observed history sequence of labels.

The regular expression is

### “[]*S1[]*D1 OR

### []*S2[]*D1 OR

### []*S3[]*D2 OR

[ [symbol] ]*S2[ [symbol] ]*D2” where the strike through denotes a point from any set other than the one that is striked through. For example [ [symbol] ] denotes any point from regions other than S3 or D2 which leaves regions (labels) S1,S2,D1, or O.

What is claimed is:

1. A method of performing an action on a portable device of an individual comprising:
receiving automatically and transparently to the individual location data wherein location data includes sequence of points traveled by the location device;
detecting automatically and transparently to the individual when the travel of the portable device satisfies one or more preset criteria that include at least comparing the sequence of points to one or more preset routes, wherein the preset route is characterized by at least a starting region that the portable device traverses through and an associated destination region that the portable device supposed to traverse through after traversing through the starting region; and
performing an action.

2. The method of claim 1 further comprising determining based on the location data one or more of the following:
an average velocity of the portable device within a predetermined time period;
a traversing time that takes for the portable device to traverse from the starting region to the destination region.

3. The method of claim 2 wherein detecting automatically and transparently to the individual when the location data satisfies the preset criteria further comprises one or more of the following:
determining that the portable traversed through the starting region and located within a predetermined distance to the destination region;
determining that the portable device traversed through the starting region and will be reaching the destination region within a predetermined time to the destination region;
determining that the portable device traversing with the average velocity above a velocity threshold;
the portable device traversing from the starting region to the destination region with the traversing time lower than a traversing time threshold.

4. The method of claim 1 further comprises establishing regions.

5. The method of claim 4 wherein the regions are part of the one or more preset routes.

6. The method of claim 4 further comprises one or more of the following:
setting the one or more of the regions to be intermediate regions;
setting the one or more of the regions to be the starting regions;
setting the one or more of the regions to be the destination regions.

7. The method of claim 6 further comprises:
grouping the one or more intermediate regions into the one or more orderly lists of the intermediate regions;
associating the one or more orderly lists with the one or more preset routes respectively.

8. The method of claim 7 wherein detecting automatically and transparently to the individual when the location data satisfies the preset criteria comprises:
determining that the portable device traverses through the starting region and the orderly list of the intermediate regions.

9. The method of claim 6 wherein detecting automatically and transparently to the individual when the location data satisfies the preset criteria comprises:
determining that the portable device traverses through the starting region and the intermediate regions that are associated with the respective preset route.

10. The method of claim 4 wherein the regions are determined based on region identification parameters selected from the group comprising:
latitude and longitude; state; country; county; zip code; address; current location of the portable device; region identified by latitude, longitude and radius; region outside an area identified by latitude longitude and radius, bus stop of specific bus route.

11. The method of claim 10 wherein establishing the regions further comprising:
triggering a start tracking option of the portable device to set current location of the portable device as a new starting region;
triggering an end tracking option of the portable device to set another location of the portable device as a new destination region;
creating a new preset route by associating the new end region with the new starting region.

12. The method of claim 4 wherein establishing the regions further comprises one or more of the following:
establishing the regions through a remote computer;
establishing the regions through the portable device.

13. The method of claim 4 wherein establishing the region further comprises:
receiving region identification parameters;
establishing regions based on the identification parameters.

14. The method of claim 1 wherein performing the action further comprises one or more of the following:
notifying the individual via the portable device;
notifying a third party via a communication device of the third party at predetermined time frames.

15. The method of claim 14 wherein notifying the individual or the third party comprises:
notifying by projecting video;
notifying by sounding an alarm;
notifying by vibration of a device wherein a device is the portable device of the individual or the communication device of the third party;
notifying by intermixing vibrations and sound of alarm on the device.

16. The method of claim 1 wherein the portable device is a cell phone.

17. Apparatus of performing an action, the apparatus comprising:
at least one location measuring unit configured to receive location points in predetermined time frames;
at least one matching unit configured to compare the location points to one or more preset routes, wherein the preset route is characterized by at least a starting region that the portable device traverses through and an associated destination region that the portable device supposed to traverse through after traversing through the starting region;
at least one perform action unit configured to perform an action via output ports.
